(19) United States
(12) Patent Application Publication
(10) Pub. No.: US 2004/0148133 A1
(43) Pub. Date: Jul. 29, 2004

(54) Collecting operational information on closed system

(76) Inventors: Sampsa Fabritius, Tampere (FI); Pasi Kolinummi, Tampere (FI); Juhani Vehvilainen, Tampere (FI)

Correspondence Address: Crawford Maunu PLLC, Suite 390, 1270 Northland Drive, St. Paul, MN, 55120, US

(21) Appl. No.: 10/702,325

(22) Filed: Nov. 6, 2003

(30) Foreign Application Priority Data
Nov. 8, 2002 (FI) 20022006

(51) Int. Cl. G06F 15/00

(52) U.S. Cl. 702/187

(57) ABSTRACT

An arrangement for collecting operational information on a closed system. The collecting system comprises an instrument to be connected functionally to a monitorable component of the closed system and a data collector comprising a register. The instrument collects operational information on the component that is transmitted onward to the data collector. The operational information is stored in the register. The collecting system can also comprise an analyzing module that determines the performance and/or power consumption of the closed system on the basis of the received operational information. The collecting system can also comprise a controlling module comprising a control algorithm and being functionally connected to the analyzing module for adjusting the performance or power consumption of the closed system on the basis of analysis information.

### FIELD OF THE INVENTION

The invention relates to closed systems and especially to collecting operational information on a closed system.

### BACKGROUND OF THE INVENTION

Customers are continuously demanding better usability of and more applications for electronic devices, such as mobile stations. Today, a mobile station is no longer used for calling only, but is it also used for many other purposes, such as calendar, game machine, Internet browser and camera. The number of such mobile applications has increased greatly along with the spreading and development of mobile stations, and new and more complex mobile applications are continuously being developed.

As the number of applications for electronic devices, such as mobile applications, grows, a better than before performance is required of the electronic device, which results in a considerable increase in the use of resources and thus also in power consumption. It is thus possible that momentarily a high performance is required of an electronic device or, on the other hand, when the applications are in a passive state, the electronic device is idle. Thus, the performance of the electronic device does not always correspond to the actual performance requirement.

It is difficult for prior-art software-based methods for collecting operational system information, such as clock pulses, and determining performance to follow the operation of a closed system, such as an ASIC circuit, and thus also the distribution of the operational capacity of the closed system, since the operation of the software in itself causes a bus load in the closed system. This is why the performance of an electronic device is generally determined from inside a closed system, which means that it is not possible to find out the locations of the actual creators of the problems. Other problems include the slowness of the collecting methods and the fact that operational information can be collected and performance determined only very late in the design by analytical methods, and even then, the result is only an estimate of the actual operational information and performance. Inaccuracy in the determination can cause operational problems in the terminal. In addition, it is not possible to determine the performance of a cache memory and the frequency of an entire closed system at all with the present methods. The complexity of the methods poses another problem, which in turn causes additional costs and an increase in the error risk.

A solution known from U.S. Pat. No. 5,164,969 measures and adjusts the performance of a RISC (Reduced Instruction Set Computer) system. The determination method in the publication is, however, based on calculating minimum and maximum numbers of continuous cycles in one RISC system event. A problem with the method is that it calculates peak values and not the continuous number of executions.

### BRIEF DESCRIPTION OF THE INVENTION

It is thus an object of the invention to develop a method and an apparatus implementing the method in such a manner that the drawbacks of the above-mentioned problems can be reduced. The object of the invention is achieved by a method, system, apparatus and software that are characterized by what is stated in the independent claims. Preferred embodiments of the invention are set forth in the dependent claims.

The invention is based on the fact that at least one monitorable component, such as a RAM or DMA component, of a closed system, such as an ASIC circuit, has an instrument connected functionally to it and arranged to collect operational information on the component being monitored, such as clock pulses arriving at the component or clock pulses that elapse during the execution of a function. The instrument is arranged to transmit the collected operational information to a data collector that is functionally connected to the instrument and comprises at least one register for storing the operational information transmitted by the instrument.

According to a preferred embodiment of the invention, the collecting system also comprises at least one analyzing module arranged to receive operational information on the monitored component transmitted from the data collector. The analyzing module is arranged to determine the performance and/or power consumption of the component on the basis of the operational information. This information obtained as a result of an analysis is herein called analysis information.

According to a second preferred embodiment of the invention, the collecting system also comprises a controlling module arranged to receive the analysis information transmitted by the analyzing module. The controlling module comprises a control algorithm implemented generally by software, by means of which the controlling module adjusts the performance and/or power consumption of the closed system on the basis of the analysis information.

The arrangement of the invention provides significant advantages. One advantage is that it is possible to apply the collecting method of operational information both to the design stage, whereby it is possible to direct design action as required, and to the finished end product at run time, whereby it is possible to adjust the performance as necessary and thus reduce the consumption of resources, which in turn permits a decrease in the operating voltage of the end product, such as mobile station. Another advantage is that hardware implementation of the collecting system of the invention is minimal, since the system can at least partly be implemented by software. The system for collecting operational information makes it possible to optimize the performance of a closed system quickly and reliably, and consequently, the design can be parameterized and the efficiency of the use of existing resources improved. Another advantage is that the software designer can easily detect the impact of his application on the performance of the closed system and thus detect if the resources allocated for software design are exceeded.

### BRIEF DESCRIPTION OF THE FIGURES

The invention will now be described in greater detail by means of preferred embodiments and with reference to the attached drawings, in which

FIG. 1 shows a simplified microcomputer and its most essential components,

FIG. 2 shows a simplified structure of a processor, and

FIG. 3 is a block diagram of a collecting system of a preferred embodiment of the invention.

### DETAILED DESCRIPTION OF THE INVENTION

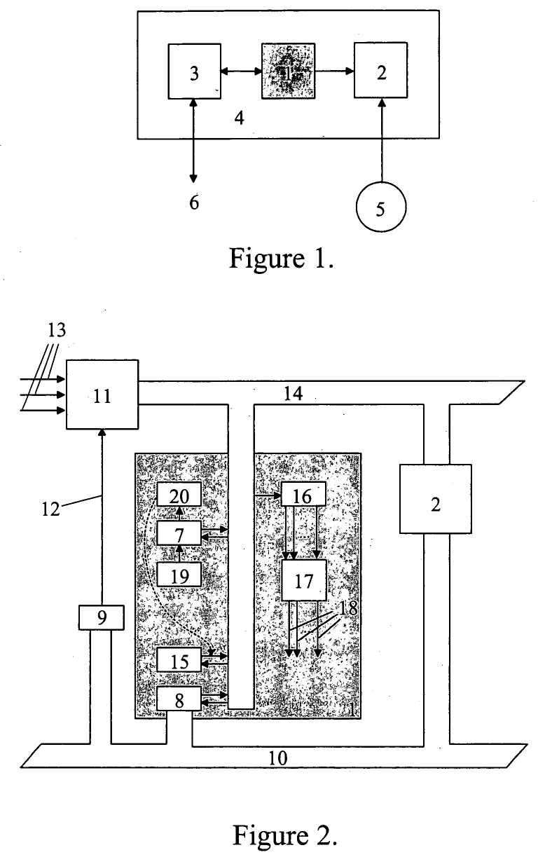

Digital electronic devices, such as mobile stations, generally comprise several microcomputers. The most important components of a microcomputer are typically a processor 1, memory 2, peripheral equipment 3 and interface logic 4 as shown in FIG. 1.

The processor 1 is the unit controlling the operation of the microcomputer and executes programs 5 stored in the memory 2, processes information in the memory 2, controls the operation of the peripheral equipment 3 for instance by processing the service requests of the peripheral equipment 3, such as interruptions, and distributes the resources of the microcomputer as necessary. The operation of the processor 1 is based on the fact that the processor 1 receives commands comprising bits.

The task of the memory 2 is to store the programs controlling the operation of the processor 1 and any information that is stored for a longer period of time. The memory 2 also contains specific data structures of the processor 1, such as the stack and interrupt vector. The memory 2 can roughly be divided into a read only memory (ROM), in which fixed programs, such as operating systems, are generally stored, and a random access memory (RAM) for read and write operations.

The peripheral equipment 3 connects the microcomputer to the outer world 6, since it is capable of transferring data in and out of the microcomputer. The processor I generally controls the operation of the peripheral equipment 3, but the peripheral equipment 3 is also capable of communicating with the processor 1. For instance, the processor 1 checks periodically whether the peripheral equipment 3 needs a service (polling) or the peripheral equipment 3 requests help from the processor 1 when necessary (interrupt).

The task of the interface logic 4 is to connect the processor 1, memory 2 and peripheral equipment 3 to each other typically by a bus logic. The bus logic can also connect the peripheral equipment 3 to the outside world 6. The buses are made up of conductors, and they can be generally divided into a control bus that transmits controls to the components connected to the processor 1, an address bus that indicates the memory address, in which data is to be stored, for instance, and a data bus in which the actual data is transmitted.

The same reference numbers are used in both FIG. 1 and 2. FIG. 2 shows the structure of the processor 1 in more detail. Before processing data, the processor 1 generally transfers the data from the external memory 2 of the processor 1 to memory locations, i.e. registers, inside the processor 1. Intermediate results generated during data processing are also kept in the registers, since it speeds up the operation of the processor. Typical registers of the processors 1 include accumulators 7 and address registers 8. When the processor 1 needs to read data from a unit, the address of an interpretive program 9 is set in the address register 8 and transferred to an address bus 10. The interpretive program 9 gives a control signal 12 to a three-mode buffer 11, as a result of which input signals 13 are transmitted to a data bus 14. During the next clock pulse, the input signals 13 are stored in the accumulator 7. The processor 1 generally also has a program counter 15, the task of which is to indicate the address of the next instruction to be executed in the memory 2, and an instruction register 16 that stores the instruction retrieved from the memory 2 so that a control unit 17 has time to interpret and execute a string of events consisting of control signals 18.

In addition to control and adjustment tasks, a second important application area of microcomputers is mathematical calculations, for the execution of which the processor 1 has an arithmetic logic unit (ALU) 19. The processor generally also comprises flags that are flip-flops set to a logical one or zero as a result of different functions. Decision-making in a microcomputer depends on the settings of different flags. For instance, a Z flag 20 is set to one when the content of the accumulator is zero. When the content is unequal to zero, the Z flag 20 is reset to zero.

An application-specific integrated circuit (ASIC) is a logic circuit that may generally have as many as several millions of logic ports formed by transistors. A clock signal, which synchronizes the operation of the logics on the circuit, is typically input into ASIC. Independent logical entities can be designed into ASICs. Thus, this type of circuit can have excellent application specific properties. ASICs are also fast, due to the short delays in the logic ports. The design of ASICs is time-consuming and relatively expensive, but the VHDL (very high-speed integrated-circuit hardware description language) language commonly used in designing them enables the use of the code in later products. Ready-made blocks that can be integrated to the circuit, i.e. IP (intellectual property blocks) blocks, such as DSP (digital signal processing) cores, processors, memory circuits and counters, are currently available for ASICs.

ASIC and FPGA (field programmable gate array) circuits are examples of closed systems. A closed system refers herein to a data processing system that, after the manufacturing process, essentially comprises the required parts, but to which, even after manufacturing, parts can be added in such a manner that a new closed system is formed after adding the parts.

In electronic devices, the operation of software requires performance of the closed system of the electronic device. At times, the need for performance is momentarily high and at times, the electronic device is idle. Thus, the requirements may vary significantly and the performance of the electronic device does not always correspond to the actual performance requirement. The prior-art methods for collecting operational information and determining performance are inaccurate, complex and slow, and their use is generally limited to monitoring only certain components of the closed system and to a certain design stage.

According to a preferred embodiment of the present invention, an interface is formed to the closed system for the software. Information on the operation of the ASIC circuit and on the distribution of the operational capacity during software functions is obtained through the interface. With this method, it is possible to find out, how the software loads the ASIC circuit and consequently to optimize for instance the consumption of resources by the software. As a result of this, it is easier to understand and illustrate the behavior or the ASIC circuit and consequently, it is also possible to analyze the impact of the changes made in the design of the ASIC circuit on the performance of the closed system more reliably and earlier than before.

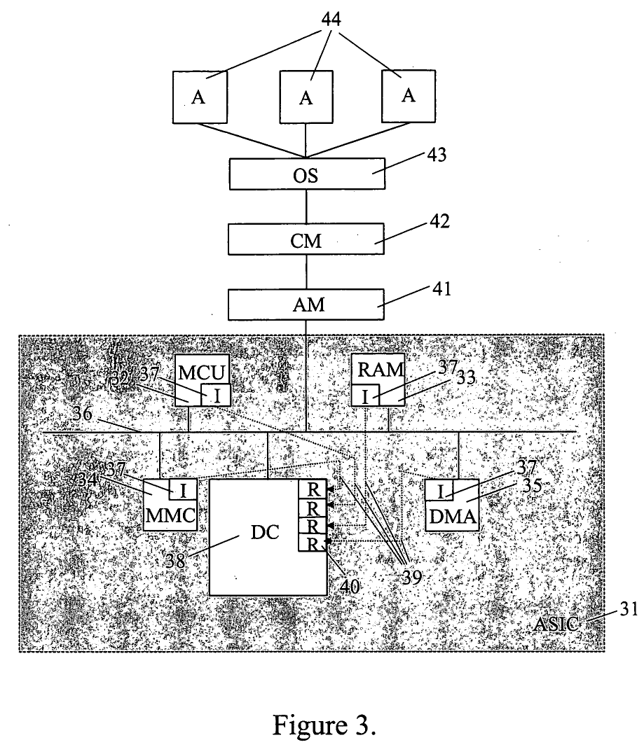

With reference to the simplified block diagram shown in FIG. 3, the following describes a collecting system according to a preferred embodiment of the invention, in which the closed system, in this case an ASIC circuit 31, of an electronic device, such as a mobile station, comprises not only a processor (micro controller unit MCU) 32, RAM memory 33, multi media card (MMC) 34, direct memory access (DMA) component 35 and an interface logic 36, but also instruments (I) 37 functionally connected to the components 32, 33, 34 and 35 to be monitored and a data collector (DC) 38 functionally connected to the instruments.

In the collecting system, the instruments 37 are arranged to collect operational information on the monitored components 32, 33, 34 and 35, such as clock pulses arriving at the components and clock pulses that elapse during the execution of a function, such as read or write operation, and during waiting. The instruments 37 are arranged to transmit this operational information onward through corresponding measuring signals 39 to the data collector 38 functionally connected to the instruments and comprising at least one register (R) 40 in real time, for instance, or in such a manner that the instrument 37 stores the operational information and the data collector 38 retrieves the information at certain intervals. The operational information of the components 32, 33, 34 and 35 is stored in the registers 40 in the data collector 38. The data collector 38 transmits the operational information onward to an analyzing module (AM) 41 of the collecting system that is arranged to determine the performance of the closed system on the basis of the operational information. The performance of the closed system is determined by comparing for instance the number of incoming clock pulses of a component with the number of clock pulses during which the component executes a function. This information can then be compared with the information of the other components to find out, for instance, whether a component waits for the action of another component for too long. The result of the determination of the performance carried out by the analyzing module 41 is analysis information, which can be used to define the properties of the ASIC circuit 31, such as internal functions, latencies and adaptation conflicts. It is possible to accurately monitor the performance of the ASIC circuit 31 on the basis of the analysis information.

Because the analyzing module 41 has a bus interface to the processors, the analysis information is available to the processors anytime. The measuring signal 39 and analyzing module 41 quantities can usually be selected during implementation. The operation of the analyzing module 41 can preferably be programmed at run time.

The analyzing module 41 is further arranged to transmit analysis information to a controlling module (CM) 42 comprising a control algorithm. The controlling module 42 is arranged to optimize the performance of the ASIC circuit 31 by controlling on the basis of the analysis information the parameters affecting the distribution of the operating capacity of the components 32, 33, 34 and 35 of the ASIC circuit 31, for example. The operation of the controlling module 42, too, can preferably be programmed at run time.

The analysis information can also be used for the reprogramming of the program, for instance. Performance can be optimized by running the processor at a lower clock frequency, for instance.

The operation of the applications (A) 44 of electronic devices is based on the operation of the operating system (OS) 43 of the electronic device. The operating system is preferably functionally connected to the controlling module 42, as a result of which the resource consumption caused by the operation of the applications 44 can be determined and controlled in accordance with the invention.

The instruments 37 can also be implemented as conductors between the components 32, 33, 34 and 35 being monitored and the data collector 38. The instruments 37 do not necessarily need to be directly connected to the component 32, 33, 34 and 35 being monitored, but it can reside anywhere as long as it is functionally connected to the component 32, 33, 34 and 35 being monitored. The data collector 38, too, can be implemented inside or outside the closed system 31 as long as it is functionally connected to the instruments. In addition, one data collector 38 can collect the operational information on the components of several different closed systems. According to a preferred embodiment, the system collects the operational information of the closed system. in order to determine and adjust the power consumption of the system. The analyzing module determines by means of the operational information, such as clock pulses, of the components for instance the operating frequencies of the components, which further help in determining the power consumption of the closed system. On the basis of the analysis information, it is possible to control the power consumption of the system.

By means of the above system for collecting operational information on a closed system, it is possible to implement a method for collecting the operational information on the closed system 31. According to one preferred embodiment of the method, operational information is collected from the monitorable components 32, 33, 34 and 35 of the closed system by means of the instruments 37 connected functionally to the components. The instruments 37 transmit the operational information onward to the data collector 38 where it is stored in at least one register 40. The operational information of the monitorable components 32, 33, 34 and 35 is transmitted to the analyzing module 41 that determines the performance of the closed system 31 on the basis of the received operational information of the components 32, 33, 34 and 35.

According to another preferred embodiment, a controlling module 42 can be functionally connected to the analyzing module 41, whereby the performance of the closed system 31 can be adjusted on the basis of the analysis information received from the analyzing module 41.

The method and system of the invention provide a reliable, fast and easily implemented way of collecting operational information on a closed system and of adjusting its performance. The collecting system makes it possible to improve the efficiency of performance and thus reduce energy consumption and the operating voltage of an electronic device. Because the system can be used already during the design stage, design-stage measures can be taken as necessary to improve the reliability of the electronic device and achieve cost savings. In addition, the collecting system and method can be used in the finished end product at run time.

Hardware implementation of the collecting systems and methods of the invention is minimal and simple, since all high-level definition and control functions can be implemented by software.

The system of the invention for collecting operational information has two different purposes of use. In a system analysis, i.e. verification, made during research and product development, the system can be used to collect the operational information of a closed system, such as ASIC, during software operation. The collecting system makes it possible to determine latencies, possible hot spots and bottlenecks generated by the closed system and caused by software operation. Finding possible problems early facilitates the design and improves the reliability of the end product. The second purpose of use is the determination of the performance of a finished electronic device at run time by means of the analyzing module 41 and the adjustment of the performance as necessary by means of a control algorithm in the controlling module 42.

The implementation of the new collecting system in a closed system and its integration as part of the software analysis tools provides a software designer the possibility to quickly and effortlessly detect the impact of an application on the operation of the closed system. The designer can enter parameters for the analysis when determining the processor load caused by the software and the software performance. In other words, a software designer can easily determine if the software module exceeds the limitations set on software design.

The above describes a system and method for collecting operational information on a closed system and for determining its performance. The collecting and adjusting functions can preferably be provided by a software product adapted to the electronic device that can comprise a software code for receiving the execution frequency of the operational modes of the components being monitored and for determining the performance and/or power consumption of the closed system on the basis of the received operational information of the components being monitored, and a software code for adjusting the performance and/or power consumption of the closed system on the basis of analysis information received from an analyzing module 41, a software code for programming the operation of the analyzing module 41 at run time and/or a software code for controlling the operation of a controlling module 42 at run time.

It is obvious to a person skilled in the art that while the technology advances, the basic idea of the invention can be implemented in many different ways. The invention and its embodiments are thus not restricted to the examples described above, but can vary within the scope of the claims.

1. A collecting system for collecting operational information on a closed system comprising at least one of the following components configured to be monitored:
a processor
a memory
peripheral equipment
an interface logic,
wherein the collecting system further comprises:
at least one instrument to be functionally connected to the monitorable component of the closed system and being configured to collect operational information on at least one of said components, and
a data collector comprising at least one register and being configured to receive operational information collected by said instrument, the register being configured to store said operational information.

2. A collecting system as claimed in claim 1, wherein
the collecting system also comprises at least one analyzing module configured to receive the operational information of said at least one component from the data collector and to determine the performance and/or power consumption of the closed system on the basis of the received operational information of the at least one component.

3. A collecting system as claimed in claim 2, wherein
the collecting system also comprises at least one controlling module comprising at least one control algorithm and being functionally connected to the analyzing module and configured to adjust the performance and/or power consumption of said closed system in response to analysis information received from the analyzing module.

4. A collecting system as claimed in claim 1, wherein
at least one of the following components is configured to be connected as part of the closed system:
the instrument
the data collector
the analyzing module
the controlling module.

5. A collecting system as claimed claim 1, wherein
said instrument is a conductor between the component being monitored and the data collector.

6. A collecting system as claimed in claim 1, wherein
said instrument is configured to store said operational information.

7. A collecting system as claimed in claim 1, wherein
said data collector is configured to receive the operational information of one or more components being monitored in the closed system.

8. A collecting system as claimed in claim 2, wherein
the operation of the analyzing module and/or controlling module is programmable at run time.

9. A collecting system as claimed in claim 1, wherein the closed system is one of the following:
ASIC (application-specific integrated circuit)
FPGA (field programmable gate array) circuit.

10. A method for collecting operational information on a closed system comprising at least one of the following components configured to be monitored:
a processor
a memory
peripheral equipment
an interface logic,
comprising
collecting operational information on at least one monitorable component of the closed system by means of an instrument connected functionally to the component,
transmitting at least part of said operational information to a data collector, and
storing at least part of said operational information in at least one register in the data collector.

11. A method as claimed in claim 10, comprising
determining the performance and/or power consumption of the closed system in an analyzing module connected functionally to the data collector on the basis of the received operational information of at least one component.

12. A method as claimed in claim 11, wherein
a controlling module is functionally connected to said analyzing module, whereby the performance and/or power consumption of said closed system is adjusted in response to the analysis information received from the analyzing module.

13. A method as claimed in claim 10, comprising
storing said operational information in said instrument.

14. A method as claimed in claim 10, comprising
receiving at one data collector the operational information of one or more components of the closed system.

15. A method as claimed in claim 11, comprising
programming the operation of the analyzing module and/or controlling module at run time.

16. An electronic device comprising a closed system that comprises at least one of the following components configured to be monitored:
a processor
a memory
peripheral equipment
an interface logic,
wherein the electronic device further comprises:
an instrument functionally connected to at least one monitorable component of the closed system and configured to collect operational information on said component, and
a data collector comprising at least one register and configured to receive the operational information collected by said instrument, the register being configured to store said operational information.

17. An electronic device as claimed in claim 16, wherein
the electronic device further comprises at least one analyzing module configured to receive from the data collector the operational information of said at least one component and to determine the performance and/or power consumption of the closed system on the basis of the received operational information of the at least one component.

18. An electronic device as claimed in claim 17, wherein
the electronic device also comprises a controlling module comprising at least one control algorithm and being functionally connected to the analyzing module and configured to adjust the performance and/or power consumption of said closed system in response to analysis information received from the analyzing module.

19. An electronic device as claimed in claim 16, wherein
the electronic device is one of the following:
a mobile station
a computer
a television.

20. A software product adaptable to an electronic device, wherein
the software product comprises:
a software code for collecting operational information on at least one monitorable component of a closed system in the electronic device, and
a software code for receiving and storing said operational information.

21. A software product as claimed in claim 20, wherein
the software product also comprises at least one of the following:
a software code for determining the performance and/or power consumption of the closed system on the basis of the received operational information of at least one component,
a software code for adjusting the performance and/or power consumption of the closed system in response to analysis information received from an analyzing module of the electronic device,
a software code for programming the operation of the analyzing module at run time,
a software code for programming the operation of a controlling module functionally connected to the analyzing module at run time.
